(19) United States
(12) Patent Application Publication
(10) Pub. No.: US 2017/0098324 A1
(43) Pub. Date: Apr. 6, 2017

(54) METHOD AND SYSTEM FOR AUTOMATICALLY CONVERTING INPUT TEXT INTO ANIMATED VIDEO

(71) Applicant: Vitthal Srinivasan, Mumbai (IN)

(72) Inventor: Vitthal Srinivasan, Mumbai (IN)

(21) Appl. No.: 14/886,103

(22) Filed: Oct. 19, 2015

(30) Foreign Application Priority Data
Oct. 5, 2015 (IN) 3773/MUM/2015

(51) Int. Cl. G06T 13/00; G06K 9/00; G10L 13/08; G06F 17/21

(52) U.S. Cl. CPC G06T 13/00; G06F 17/21; G06K 9/00463; G10L 13/08; G06T 2213/04

(57) ABSTRACT

The present invention provides a system and a method for automatically converting input text into animated video, optionally with a voiceover. Specifically, the present invention programmatically converts the input text, which is in the form of XML, HTML, RTF, or simple word document into an animated video. The animated video is generated via a series of steps, which involve summarizing and processing the text into an intermediate markup, which is then drawn, in the form of an animated whiteboard video including vector images and both spatial (perspective camera movements, zooms and pans) and semantic accentuation (highlighting, variation in speed of animation). Further, the voiceover is included automatically and the voiceover can be modified manually as a summary of the given input text. Furthermore, the generated video can be post processed by varying the time duration, background music, voiceover, splicing of video at specific points and the video can be uploaded or stored in cloud storage or to hard disk.

### FIELD OF INVENTION

The embodiments herein generally relate to a method and system for automatically converting text into an animated video. More specifically, the embodiment provides a system and a method to generate an animated video for a given text input of various formats such as word, RTF, HTML, XML, spreadsheet, Google Doc, PDF, PPT, and so on.

### BACKGROUND AND PRIOR ART

These days, information sharing is exploding: people share far more information than in times past, and using far more formats: photographs, tweets, blog posts, as well as more traditional formats such as maps, charts, graphs, pictures, projected images, business presentations and so on. Empirical evidence, as well as some research, shows that the human brain is wired to absorb information most efficiently when that information is in the form of structured text in combination with images and video (spatial, animated content). The format of a whiteboard animation has been found in some studies to significantly boost retention and recall; the animated whiteboard video presentation format helps the audience to grasp video information far more easily than information in text format. Whiteboard video animated presentations improve audience understanding and are effective for recall because they hold user attention, and specifically stimulate viewer anticipation.

Currently, computer operators using specialized computer applications to generate animated video presentations manually. This method of generating the animated video presentation manually is difficult, expensive and time-consuming: a team of content creators, animators and editors is generally required. Firstly, the content of the video presentation is drafted and according to that, the video templates, objects, and characters are selected from a pre-defined database. After that, the video presentation is developed in a sequence according to the content. The method may take anywhere from hours to weeks to obtain the final video presentation.

Even though the preparation of the video presentation is very expensive and time-consuming, the final output might not match the content exactly—consequently the processes of summarizing and structuring text and images and determining the kind of animation needs to be performed manually and iteratively. Therefore, for video animation creation, the method requires an artist, animator, editor and so on. Hence, the video animation creations are one-off animations but not built for scale. Lastly, while there do exist both automated and manual voiceover techniques, these are not built seamlessly into the production flow of animated video presentations.

Given the cost and time complexity of creating animated video presentations, and given the exploding popularity and proven efficacy of this form of information transmission, there exists a need in the prior art to provide an automated system for preparing presentations, animated whiteboard videos, well-formatted text. Further, there is need for a method, which automates the production of the animated whiteboard video with text input summarizing to its most core elements with highlights and adds a voiceover in an automated manner according to the requirement.

### OBJECTS OF THE INVENTION

Some of the objects of the present disclosure are described herein below:

A main object of the present invention is to provide a system and method to convert automatically an input text into an animated video with a narration of summarized text. This narration can be generated by a human narrator.

Another object of the present invention is to provide a system and method to automatically convert an input text for example word, RTF, spreadsheet, Google Doc, PDF, PPT, and so on into an automatic animated video with audio/voiceover. Further, this narration can be automatically generated by the computer program.

Still another object of the present invention is to provide a system and method to automatically convert an input text into a combination of structured and summarized text in animated video form with a text highlights and voiceover, wherein the system to automatically summarize and highlight key portions of the input, using techniques such as natural language processing.

Yet another object of the present invention is to provide a system and method to convert input text file into an animated video automatically without a need of manual animation creation.

Another object of the present invention is to provide a system and method to convert text file into an animated video automatically without using the pre-existing design template database.

The other objects and advantages of the present invention will be apparent from the following description when read in conjunction with the accompanying drawings, which are incorporated for illustration of preferred embodiments of the present invention and are not intended to limit the scope thereof.

### SUMMARY OF THE INVENTION

The embodiments herein provides a system and method for automatically converting input text into animated video, wherein the system comprises of an input module configured to get the input text from the user using an user interface device and/or using any input method, an information extraction engine configured to analyze the gathered input text, an image vectorization module configured to vectorize the embedded or linked images obtained from the input text to provide vector image, an information interpretation engine configured to to interpret the extracted information to deduce the raw data such as timelines, series, numbers into visual representation which includes charts, graphs and analytical representation, a text pre-processing, summarization and structuring engine configured to process the interpreted information to get the structured summarized text and to use a variety of text summarization techniques, a voiceover module configured to generate the audio; and an audio sync module configured to include the generated audio with the animation, an animation engine configured to create animation definition in the form of markup by utilizing the structured summarized text and converting animation markup into animation, to recognize which particular animation template can be applied and to run on more and more different types of data and adaptively add one or more animation templates to the pre-existing template library, and video conversion module configured to convert the animation into a required video. The input text includes but not limited to documents, slides, presentations and spreadsheets.

In accordance with an embodiment, the information extraction engine includes an adapter layer for extracting information from different formats of input, wherein each adapter responsible for identifying the intrinsic details of the specified format and converting the specified format to an output in a well defined common format, wherein said adapter layer responsible for serving as a plug and play for consuming information in new formats, wherein the adapter layer forwards the format changes to subsequent engines when there is a change in the format of input.

In accordance with an embodiment, a computer implemented method for automatically converting input text into animated video, wherein the method comprising the step of receiving input documents from the user, extracting information from the input document, cleaning, splitting, and collation of extracted information to get the information in a structured manner with highlights and engine readable, vectorizing of embedded or linked image of input documents interpreting the extracted information, pre-processing the interpreted information, summarizing and structuring the interpreted information, generating voiceover audio and synchronizing the generated audio with the animation, creating animation definition in the form of markup from the summarized structured information, converting animation markup into animation, and converting the animation into required video.

In accordance with an embodiment, the information extraction step includes to analyze the input text to identify the highlights of the input text, wherein the highlights include font style, bold, italic, image appearance, audio or voiceover requirement, and sessions where the text needs to be summarized rather than using in current form, wherein the extracted information includes text, formatting, metadata and embedded or linked images.

In accordance with an embodiment, the text pre-processing step includes identifying text boundaries, wherein the text boundaries includes sentences, words and other logical blocks. In accordance with an embodiment, the summarization step includes utilizing one or more text summarization techniques, wherein the structuring step includes to bring the summaries in a logical flow.

In accordance with an embodiment, the creation animation step includes defining animation for the text summaries, formatting, metadata and images by using a custom markup, recognizing the animation template to be applied on animation, creating a custom animation for the content in the form of a markup which is understood by the animation generation, and specifying all the characteristics of the animation and audio.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an exemplary architecture of the system for text to animated video converter, according to an embodiment therein;

FIG. 2 illustrates a computer implemented method for automatically converting input text to automatic animated video, according to an embodiment therein;

FIG. 3 illustrates a computed implemented method of information extraction for input text to automatic animated video converter, according to an embodiment therein;

FIG. 4 illustrates a computer implemented method of information interpretation for input text to automatic animated video converter, according to an embodiment therein; and

FIG. 5 illustrates a computer implemented method of animation definition for input text to automatic animated video converter, according to an embodiment therein.

### DETAILED DESCRIPTION OF PREFERRED EMBODIMENTS

The embodiments herein, and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

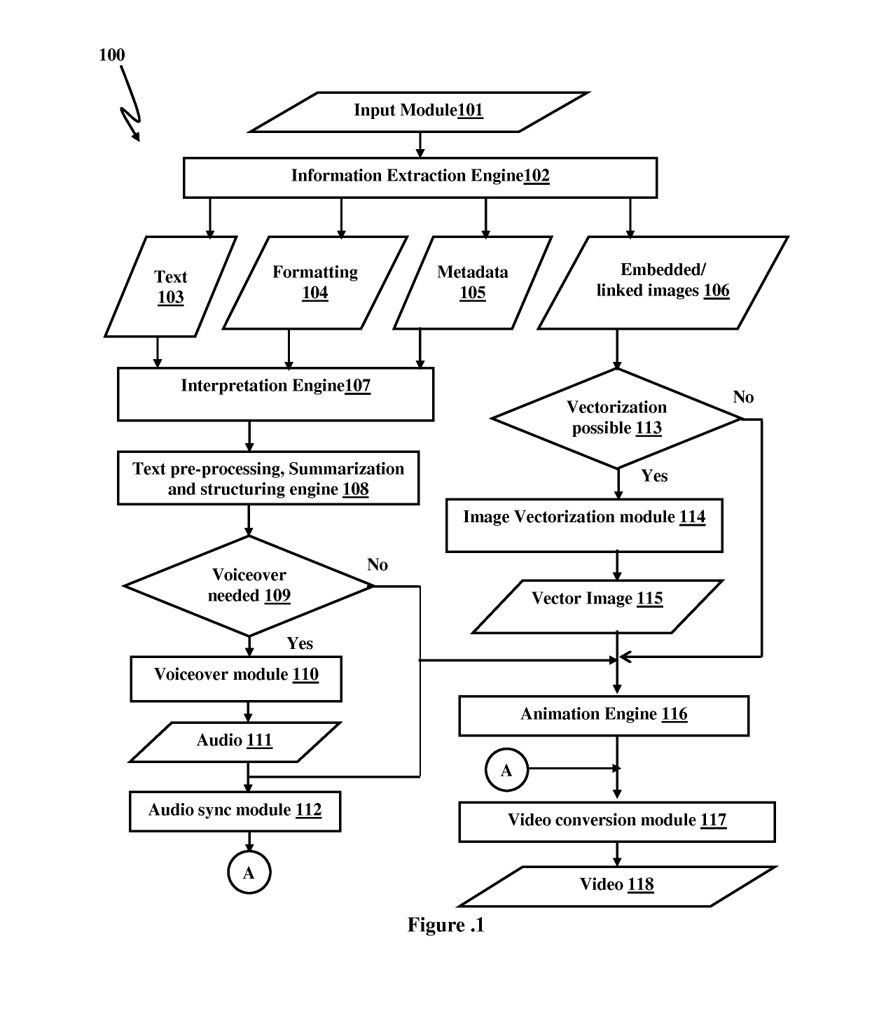

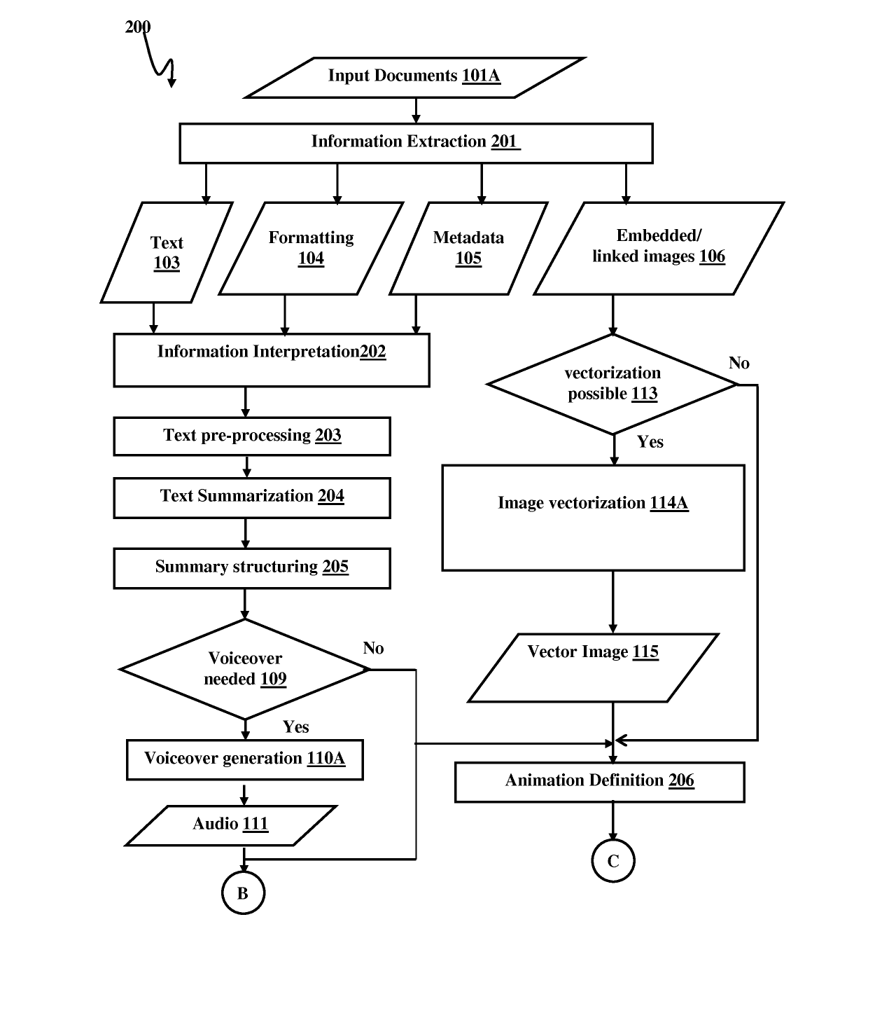

As mentioned above, there remains a need for a system and method to automatically convert input text into an animated video with a voiceover, wherein the text input can be a simple document, RTF, HTML, XML, PDF, PPT, spreadsheet and so on. The embodiments herein achieve this, by providing a structured, summarized and engine readable text input to an animation engine through various engines to get an animated video with synchronized audio as a final output. Referring now to drawings, and more particularly to FIGS. 1 through 5, where similar reference characters denote corresponding features consistently throughout the figures, there are shown preferred embodiments. As used herein, the term “and/or,” when used in a list of two or more items, means that any one of the listed items can be employed by itself, or any combination of two or more of the listed items can be employed.

It is to be noted that even though the description of the invention has been explained for input text to animated video conversion, it should, in no manner, be construed to limit the scope of the invention. The system and method of the present invention can apply to various text formats of inputs including but not limited to word, RTF, HTML, XML, spreadsheet, Google Doc, PDF, PPT, and so on.

FIG. 1 illustrates an exemplary architecture of the system 100 for input text to automatic animated video converter, according to an embodiment. The system 100 for automatically converting input text into automated animation video, wherein the system 100 comprises of an input module 101, an information extraction engine 102, an image vectorization module 114, an information interpretation engine 107, a text pre-processing, summarization and structuring engine 108, a voiceover module 110, an audio sync module 112, an animation engine 116, and video conversion module 117.

According to an embodiment, the input module 101 can be configured to get input text [can also be referred as Input documents or text file] from the user using an user interface device and/or using any input method, wherein the input text can be any form of text including but not limited to documents, slides, spreadsheets in a variety of formats that can be understood by the engine.

According to an embodiment, the information extraction engine 102 can be configured to analyze the gathered input text. Particularly, the information extraction engine 102 may include an adapter layer, which can extract information from different formats of input. Accordingly, each adapter can identify the intrinsic details of the specified format and converting the specified format into an output in a well defined common format. Further, the adapter layer may serve as a plug and play for consuming information in new formats. Whenever there is a change in the format of input, the adapter layer can bring and/or forward the changes to the subsequent engines.

According to the embodiment, the extracted input information may pass through the method of information cleaning, splitting, and collation to get the information in a structured manner with highlights and engine readable, wherein the extracted input information can be divided into text 103, formatting 104, meta data 105 and embedded or linked images 106. In case, the extracted input information has any embedded or linked images 106 then the system may check for possibility of the image vectorization 113. In an embodiment, the image vectorization module 114 can be configured to vectorize the embedded or linked images 106 to provide vector image 115. In case of no possibility for image vectorization then the embedded or linked images 106 may be diverted towards the animation engine 116.

In an embodiment, the interpretation engine 107 can be configured to interpret the extracted information to deduce the raw data including but not limited to timelines series, numbers and so on into visual representation which includes but not limited to charts, graphs and analytical representation.

In an embodiment, the text pre-processing, summarizing, and structuring engine 108 can be configured to process the interpreted information to get the structured summarized text. The engine 108 can be responsible for identifying text boundaries. Further, the engine 108 can be responsible to use a variety of text summarization techniques i.e. statistical or linguistic approaches. The compression of the text is configurable based on the where the animation engine is being used. Standard text and natural language-processing algorithms for instance to rank the sentences in a document in order of importance can be applied here.

In an embodiment, the animation engine 116 can be configured to create animation definition in the form of markup by utilizing the structured, summarized text and converting the animation markup into animation. Simultaneously, the system may check the requirement of a voiceover 109 for the animation. In case, the animation doesn't require voiceover then the animation engine 116 may start the method without audio or voiceover. The animation engine 116 can recognize which particular animation template can be applied. The recognition can be determined via a match between the logical structure and the set of templates over a time. As the animation engine 116 runs on more and more different types of data then the engine 116 may adaptively add one or more animation templates to the pre-existing template library. If no pre-existing animation template specified, which matches the logical sub-topics, then the animation definition step may create a custom animation for the content. In case of custom animation, the logical sub-topics are spatially laid out whiteboard style, the right order in which they are animated is determined and specific animation transitions are applied to each logical block. The formatting and semantic information may be used to highlight information and the entire method may be timed piece-by-piece keeping to an overall timeline in sync with the audio generated.

In an embodiment, the voiceover module 110 can be configured to generate the audio, in case the animation requires voiceover.

In an embodiment, the audio sync module 112 can be configured to include the generated audio 111 with the animation.

In an embodiment, the video conversion module 117 can be configured to convert the animation into a required video 118. Thus, the system provides the automatic animated video for given input text of any format.

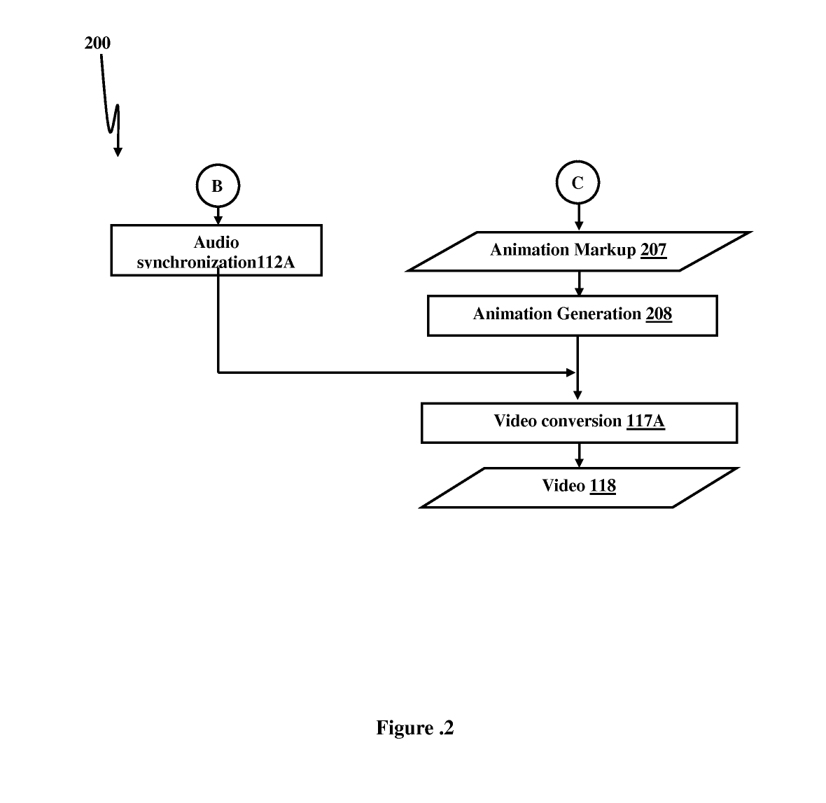

Exemplary methods for implementing system of providing text to automatic animated video are described with reference to FIG. 2 to FIG. 5. The methods are illustrated as a collection of operations in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be deleted from the methods without departing from the spirit and scope of the subject matter described herein. In the context of software, the operations represent computer instructions that, when executed by one or more processors, perform the recited operations.

FIG. 2 illustrates a computer implemented method 200 for automatically converting input text into animated video, according to the embodiment. Accordingly, the method for automatically converting input text to animated video comprising the step of receiving input documents from the user, extracting information from the input document, cleaning, splitting, and collation of extracted information to get the information in a structured manner with highlights and engine readable, interpreting the extracted information, pre-processing the interpreted information, summarizing and structuring the interpreted information, creating animation definition in the form of markup from the summarized structured information, and converting the animation definition/animation markup into animation and then into required video. The method further comprises of vectorizing of embedded or linked image of input documents. In further, the method comprises of generating voiceover audio and synchronizing the generated audio with the animation.

According to an embodiment, the input document 101A can be obtained from the user for converting the input document to automatic animated video, wherein the input document 101A can be any form of text which includes but not limited to documents, slides, spreadsheets in a variety of formats that are understood by the engine, and then the information is parsed and extracted correctly. The documents may be Google docs, HTML, PDF, text and so on; the spreadsheets may be Excel, Google sheets, CSV and so on; and the presentations may be PPT, Google slides and so on.

At the information extraction 201 step, the input document 101A may be analyzed to identify the highlights of the input document which can include but not limited to font style, bold, italic, image appearance, audio or voiceover requirement, and sessions where the text needs to be summarized rather than using in current form. Accordingly, the input document can be divided into several adapter layers according to the input format. Therefore, each adapter layer can identify the intrinsic details of the specified format and converting the specified format to an output in a well defined common format.

According to the embodiment, the extracted information may be passed through the step of information cleaning, splitting, and collation to get the information in a structured manner with highlights and engine readable, wherein the extracted information can be divided into text 103, formatting 104, metadata 105 and embedded and/or linked images 106. In case, the extracted input information has any embedded or linked images 106 then the system may check for possibility of the image vectorization 113, In case of no possibility for image vectorization then the embedded or linked images 106 may be diverted towards the animation engine 116. The embedded or linked the images 106 can be downloaded in raster or vector form. The raster image formats can be thought of as images in which information may be represented in pixel-by-pixel formats, while the vector formats use geometric primitives to represent the image. Because the vector image formats consist of primitives, and these primitives can be rendered in some order, and vector formats are suitable inputs for an animation. Raster images are converted to vector (e.g SVG) forms, so as to allow the drawing and other transition animations. These images are tagged with the source and the associated text.

At the image vectorization 114A step, the embedded or linked images 106 may be vectorized to provide vector image 115 by using the image vectorization module 114.

At the information interpretation step 202, the extracted information may be interpreted to deduce the raw data, wherein the raw data includes but not limited to timelines series, numbers and so on into visual representation which can include charts, graphs and analytical representation. The extracted information may not always be understood and summarized literally. In many cases a meta level of understanding may be required i.e. the information has to be interpreted in specific ways e.g. numbers need to be represented as time series data, chart data etc. This requires an understanding of the meaning of the data i.e. the semantics. Additional insights or second level deductions are made from the raw data. This may then merged together with the raw or deduced information from other streams.

At the text pre-processing step 203, the system may identify text boundaries, wherein the text boundaries include but not limited to sentences, words and other logical blocks. Further, stop words or other commonly used phrases, which do not add to the semantic score of the information, are removed and then the word stems might be removed for ease in text summarization step 204.

At the text summarization step 204, one or more text summarization techniques such as statistical or linguistic approaches can be utilized. However, the compression of the text may be configurable based on usage of the animation engine. According to the standard text and natural language-processing algorithms, to rank the sentences in a document are arranged in the order of importance.

At the summary structuring step 205, the summarized text may be structured to bring the summaries in a logical flow, and optionally manual intervention can also be included to get the best possible structure. Accordingly, the extracted text summaries may be structured into logical units which can be animated. For instance, what elements belong in the same scene? or in the same frame?

At the voiceover needed step 109, the system may check the requirement of a voiceover for the animation. In case, the structured summary text does not require voiceover then the structured summary text may be transferred to animation engine to covert into animation without audio or voiceover. In case, the structured summary text requires voiceover, then at voiceover generation step 110A, the audio 111 may be generated. Further, at audio synchronization step 112A, the generated audio 111 may be synchronized with the animation.

At the animation definition step 206, it forms the core step of the animation engine 116, wherein the text summaries, formatting, metadata and images are available and animations for each of these are defined. Further at step 206, a pre-existing animation template can be thought of as similar to a template slide in presentation software for example MS PowerPoint. Additionally, the animation definition step 206 can recognize which particular animation template can be applied. The recognition can be determined via a match between the logical structure and the set of templates over a time. As the animation definition step 206 runs on more and more different types of data then the engine 116 may adaptively add one and more animation templates to the pre-existing template library. If no pre-existing animation template specified, which matches the logical sub-topics, then the animation definition step may create a custom animation for the content. In case of custom animation, the logical sub-topics are spatially laid out whiteboard style, the right order in which they are animated is determined and specific animation transitions are applied to each logical block. The formatting and semantic information may be used to highlight information and the entire method may be timed piece-by-piece keeping to an overall timeline in sync with the audio generated.

At the animation markup step 207, the system can specify all the characteristics of the animation and the audio completely and exhaustively. At the animation generation step 208, the animation engine 116 can read and understand the animation markup and actually generate and run the animations on display by keeping the attributes specified in the markup.

At the video conversion step 117A, the generated animation can be converted to a video in a specified format, which can be stored or shared in variety of ways, for instance to cloud storage including but not limited to YouTube, Google Drive or saving the video to hard disk. Further at step 117A, the generated animation can be edited at specific points by speeding or slowing the timeline; adding background music; adding voiceover (automatic or manual); splicing the video.

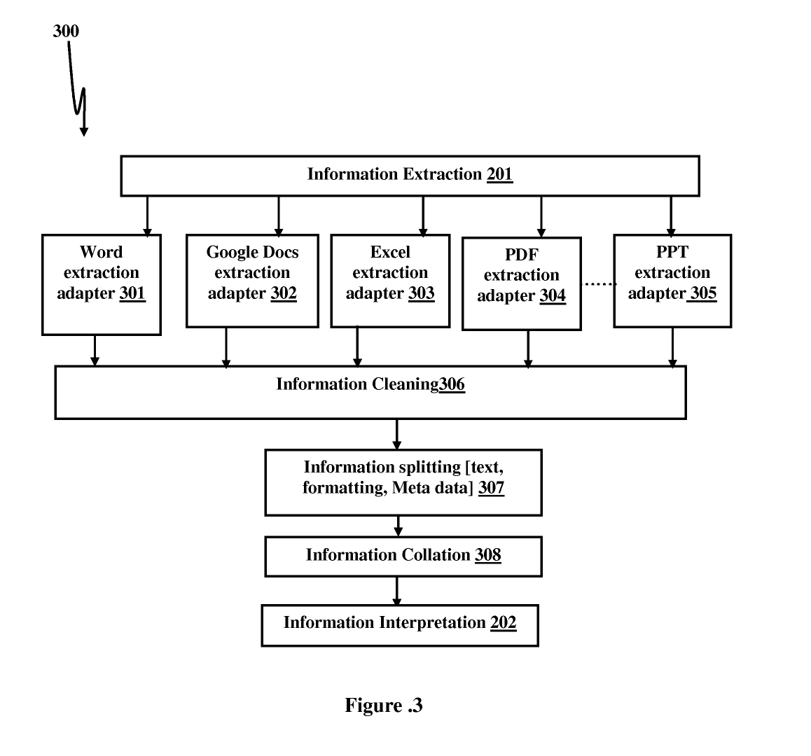

FIG. 3 illustrates a method of information extraction 300 for input text to automatic animated video converter, according to an embodiment. Accordingly, the input can be divided into several adapter layers according to the input format. Therefore, each adapter can identify the intrinsic details of the specified format and converting the specified format to an output in a well-defined common format. The adapter layers are divided as word extraction adapter 301, Google Docs extraction adapter 302, Excel extraction adapter 303, PDF extraction adapter 304, PPT extraction adapter 305 and so on. Further, the adapter layer can serve as a plug and play for consuming information in new formats. Whenever there is a change in the format, the adapter layer can bring the changes to the engine.

At the information cleaning step 306, the information in the sources may have extraneous markup or other metadata, which are not useful for example HTML markup, Meta tags and so on. Therefore at step 306, the extraneous markup or other metadata may be removed before extracting the useful contents.

At the information splitting step 307, the system may split the cleansed information into textual content (i.e. characters, words sentences and so on), formatting (i.e. highlights, bold, underlines, bullets and so on), metadata (i.e. order, page numbers, associated images and so on), and the actual embedded or linked images. From each source, the information for splitting may be extracted.

At the information collation step 308, the system may collectively aggregates the information category wise from each source, and then the processed information is tagged with the corresponding sources. The information is available as a whole and identifiable by the source. Then the collated information may be forwarded to the information interpretation step 202.

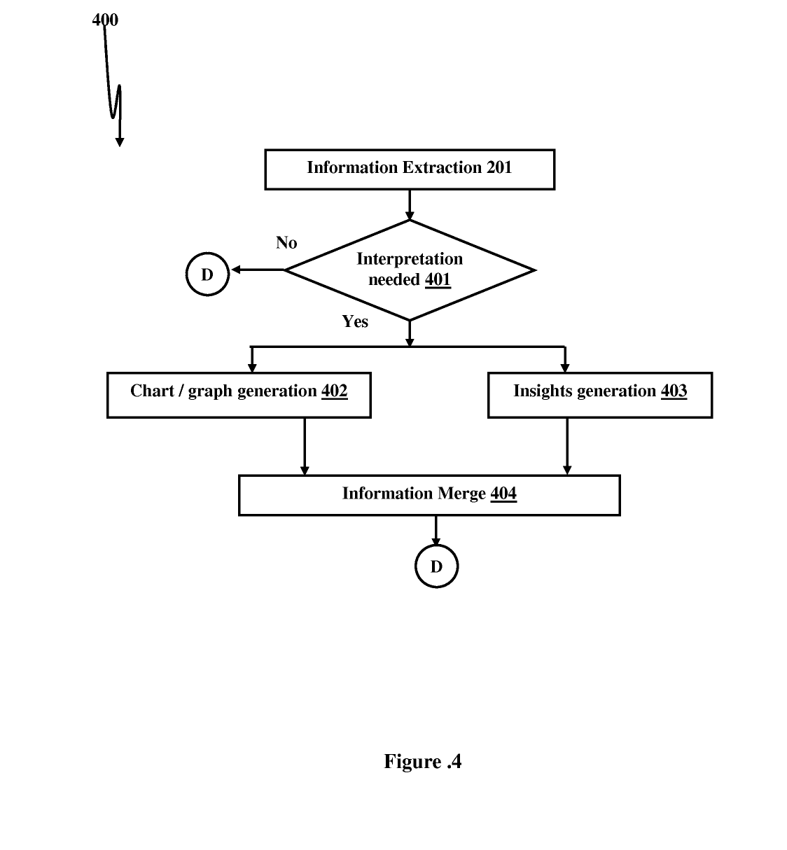

FIG. 4 illustrates a method of information interpretation 400 for text to automatic animated video converter, according to the embodiment. In many cases, the extracted information may not always be understood and summarized literally. Accordingly, a meta level of understanding may be required. That is the information may need to be interpreted in specific ways, for example numbers need to be represented as time series data, chart data and so on. The information interpretation requires an understanding of the meaning of the data i.e. the semantics. Further, additional insights or second level deductions can be made from the raw data. Then the processed data may be merged together with the raw or deduced information from other streams.

At the interpretation needed step 401, the system may method check the extracted information needed any interpretation or not. If the extracted information does not require any interpretation, then the extracted information may be forwarded to the animation definition step 206. Otherwise, if the extracted information requires any interpretation then chart/graph 402 or insights 403 may be generated. At the information merge step 404, the generated chart/graph 402 or insights 403 may be merged.

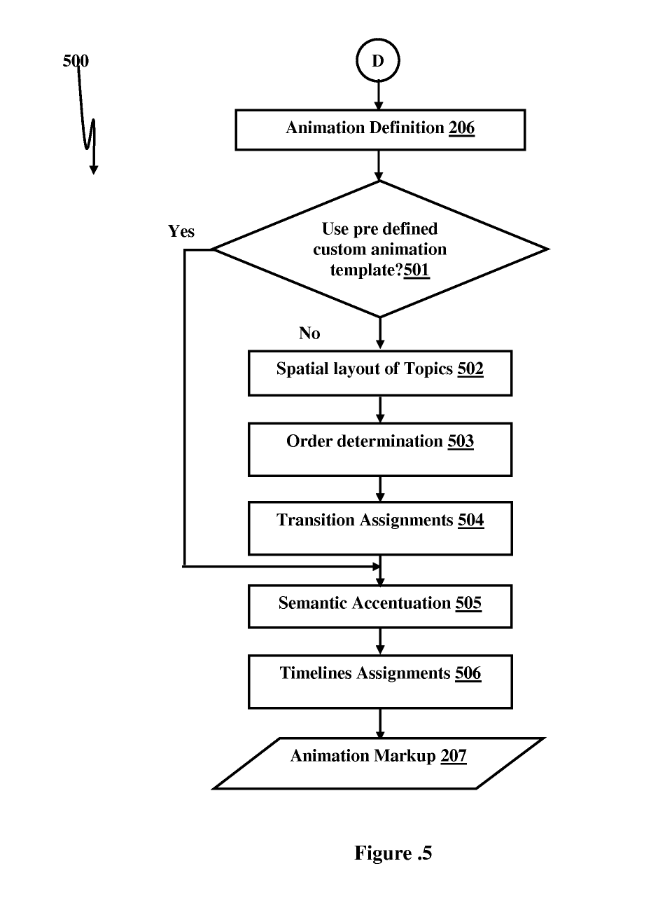

FIG. 5 illustrates a method of animation definition 500 for text to automatic animated video converter, according to the embodiment. The animation definition 206 step forms the core step of the engine, wherein the text summaries, formatting, metadata and images are available and animations for each of these are defined. At step 501, the system may determine whether pre defined custom animation template can be used or not. In case no pre-defined custom animation template, at step 502, the logical sub-topics are spatially laid out whiteboard style. At step 503, the system may determine the right order in which they need to be animated. At step 504, the transition assignments are configured, wherein specific animation transitions are applied to each logical block. At step 505, semantic accentuation may be applied to the animation, wherein the formatting and semantic information can be used to highlight information. At step 506, timelines assignments can be created according to the content, wherein the entire method is timed piece-by-piece keeping to an overall timeline in sync with the audio generated. If pre-defined templates present according to the content then the step may directly shift to the semantic accentuation 505. At the animation markup 207, the system can specify all the characteristics of the animation and the audio completely and exhaustively.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A system for automatically converting input text into animated video, wherein the system comprises of
an input module configured to get the input text from the user using user interface device and/or using any input method;
an information extraction engine configured to analyze the gathered input text;
an information interpretation engine configured to interpret the extracted information to deduce the raw data into visual representation which includes charts, graphs and analytical representation;
a text pre-processing, summarization and structuring engine configured to to process the interpreted information to get the structured summarized text;
an animation engine configured to create animation defination in the form of markup which defines the complete animation collectively and exhaustively by utilizing the structured, summarized text and generating an animation from the markup; and
video conversion module configured to to convert the animation into a required video.

2. The system of claim 1, wherein the system further comprises of
an image vectorization module configured to vectorize the embedded or linked images obtained from the input text to provide vector image.

3. The system of claim 1, wherein the system further comprises of
a voiceover module configured to to generate the audio; and
an audio sync module configured to include the generated audio with the animation.

4. The system of claim 1, wherein said input text includes documents, slides, presentation and spreadsheets.

5. The system of claim 1, wherein the information extraction engine includes an adapter layer for extracting information from different formats of input, wherein each adapter is responsible for identifying the intrinsic details of the specified format and converting the specified format to an output in a well defined common format.

6. The system of claim 5, wherein said adapter layer responsible for serving as a plug and play for consuming information in new formats, wherein the adapter layer forwards the format changes to subsequent engines when there is a change in the format of input.

7. The system of claim 1, wherein said deduced raw data includes timelines, series, numbers.

8. The system of claim 1, wherein said text pre-processing, summarizing, and structuring engine further configured to use a variety of text summarization techniques.

9. The system of claim 1, wherein said animation engine further configured to recognize which particular animation template can be applied via a match between the logical structure and the set of templates over a time.

10. The system of claim 9, wherein said animation engine further configured to run on more and more different types of data and adaptively add one or more animation templates to the pre-existing template library.

11. A computer implemented method for automatically converting input text into animated video, wherein the method comprising the step of
receiving input documents from the user;
extracting information from the input document;
cleaning, splitting, and collation of extracted information to get the information in a structured manner with highlights and engine readable;
interpreting the extracted information;
pre-processing the interpreted information;
summarizing and structuring the interpreted information;
creating animation definition in the form of markup from the summarized structured information and converting the animation markup into animation; and
converting the animation into required video.

12. The method of claim 11, wherein the method further comprising of
generating voiceover audio and synchronizing the generated audio with the animation.

13. The method of claim 11, wherein the information extraction step includes to analyze the input text to identify the highlights of the input text, wherein the highlights include but not limited to font style, bold, italic, image appearance, audio or voiceover requirement, and sessions where the text needs to be summarized rather than using in current form.

14. The method of claim 13, wherein the extracted information includes text, formatting, metadata and embedded or linked images.

15. The method of claim 14, wherein the method further comprising of
vectorizing of embedded or linked image of input documents.

16. The method of claim 11, wherein the text pre-processing step includes indentifying text boundaries, wherein the text boundaries includes sentences, words and other logical blocks.

17. The method of claim 11, wherein the summarization step includes utilizing one or more text summarization techniques, wherein the structuring step includes to bring the summaries in a logical flow.

18. The method of claim 11, wherein said creation animation step includes
defining animation for the text summaries, formatting, metadata and images by using a custom markup;
recognizing the animation template to be applied on animation; and
creating a custom animation for the content in the form a markup.

19. The method of claim 18, wherein said creation animation step further includes specifying all the characteristics of the animation and audio.
